(19) United States
(12) Patent Application Publication
(10) Pub. No.: US 2015/0373173 A1
(43) Pub. Date: Dec. 24, 2015

(54) UNIFIED USER EXPERIENCE FOR SMART PHONE WITH DEFAULT INTEGRATED VOIP VOICE, VOIP MESSAGING, VOIP VIDEO, AND VOIP CONFERENCING CAPABILITIES

(71) Applicant: Invariant Telecom, LLC., Milford, DE (US)

(72) Inventor: Rasel Taher, Chittagong (BD)

(73) Assignee: Invariant Telecom, LLC.

(21) Appl. No.: 14/748,083

(22) Filed: Jun. 23, 2015

Related U.S. Application Data
(60) Provisional application No. 62/015,830, filed on Jun. 23, 2014.

(51) Int. Cl. H04M 1/253

(52) U.S. Cl. CPC H04M 1/2535; H04W 84/042

(57) ABSTRACT

A smart phone includes VoIP circuitry that enables the smart phone to make and receive voice and video calls and text messages over a data network using VoIP. The smart phone also includes GSM circuitry that enables the smart phone to make and receive voice and text messages through a GSM network. A unified user experience is created for sending and receiving phone calls, video calls, text messages, and conferencing over VoIP, as well as for sending and receiving phone calls, enabling conferencing, and text messages over the GSM phone network.

### CROSS-REFERENCE TO RELATED APPLICATION

This application claims the benefit of U.S. Provisional Application No. 62/015,830, filed on Jun. 23, 2014. The subject matter thereof is hereby incorporated herein by reference in its entirety.

### FIELD

This invention relates to smart phones, that is, telephones (usually mobile) that combine the functions of a telephone and a computer. As used herein, “smart phone” also shall include tablets and other devices that provide both telephone and computer capabilities. Specifically, this invention relates to a smart phone that uses the Voice over IP Protocol (“VoIP”) over a data connection, such as GSM, 3G or 4G network, or Wi-Fi when communicating with other callers who have VoIP voice or video conference calling or when sending text messages, uses the GSM standard to function as a telephone when making voice calls or sending text messages to other callers who use GSM, and allows VoIP or video conference calling between both VoIP callers and GSM callers. This invention also relates to connecting smart phones at the operating system level through a VoIP server to create a VoIP Intranet through an improved or updated phone contacts user interface.

### BACKGROUND

Conventional wired telephone systems originally used switches to established electronic circuits between callers, and voice signals were then transmitted between the callers over these established circuits. This was called circuit switching. When the telephone was first adopted, the circuits were established by operators manually plugging and unplugging wires, but later this switching was performed electronically. All telephones in the World can be connected to each other using this circuit switching, and the entire network is known as the public switched telephone network.

Wireless telephone systems initially also used circuit switching, but have evolved to use packet switching, in which data is split into multiple packets, the packets are sent to their destination, and then reassembled at the destination. The packets can be sent over wired or wireless connections.

Most data transmitted over smart phones is now digital, that is, represented as “1”s or “0”s, in a binary code.

Wireless communications systems have evolved over several generations, with each generation using different communications protocols (standards), and often also using different radio frequencies. Further, countries sometimes differ in how they allocate frequencies for different uses and for different protocols.

Some generations of communications protocols are not backwards compatible, meaning that devices using only a later generation protocol cannot communicate with devices using only an earlier generation protocol. For this reason, devices are commonly made so that they can use multiple generations of protocols.

Original radio telephones, sometimes called 0G, were part of the existing telephone circuit switched network, in which a dedicated circuit is created between two parties who communicate, and only those parties' communications are carried by that circuit. These original radio telephones communicated voice only.

1G was the first generation of so-called “cellular” telephones, because 1G mobile telephones used a network of radio towers, in which each tower provides coverage for a particular area, called a “cell.” In 1G phones, the telephone analog-encoded voice signals onto carrier radio waves, which were then sent to a cellular network's radio towers.

2G was the second generation of cellular telephones, in which the telephone digitally-encoded voice and data signals using the “GSM” standard onto carrier radio waves, which were then sent to the cellular network's radio towers. 2G achieved wide market penetration and is still commonly used as “EDGE” (Enhanced Data rates for GSM Evolution)—a backwards compatible extension of GSM that increased transmission speed using more sophisticated phase shift modulation.

GSM is a Time-Division Multiple-Access (TDMA) spectrum-sharing standard developed by the European Telecommunications Standards Institute (ETSI) to describe protocols for second generation (2G) digital cellular networks used by mobile phones. GSM is a cellular network, which means that cell phones connect to it by searching for cells in the immediate vicinity. GSM became the de facto global standard for mobile communications with over 80% market share. The GSM Association estimated in 2010 that technologies defined in the GSM standard serve 80% of the global mobile market, encompassing more than 5 billion people across more than 212 countries and territories, making GSM the most ubiquitous of the many standards for cellular networks. Conventional wired telephone systems can communicate with GSM telephones.

3G is third generation, uses spread spectrum technologies, and requires higher data transfer rates, and is not backwards compatible with 2G or GSM.

4G does not use spread spectrum and the technical requirements for 4G require higher throughput than 3G. However, some systems have been marketed as 4G, even though they do not meet the technical requirements for 4G.

As used herein, the term “data connection” shall include all data connections offered by mobile carriers including those data connections utilizing GSM, 3G, and 4G technologies.

The Internet uses a different set of protocols, called “TCP/IP”. Under this protocol, each packet of data is broken into discrete packets using a process called “packetizing”. Each of the packets is given a label that contains the Internet Protocol address, or “IP address”, of the destination to which the packet is being sent. The packets are then sent through the network and reassembled at their destination. In this protocol, different packets can be sent via different routes, if one or more links or nodes becomes overloaded or inoperable.

Devices connected to the Internet must have an IP address. A device may have a “static” or “fixed” IP address, that is permanently associated with that device, or a device may have a “dynamic” IP address that is assigned when the device is first connected to the Internet, and then released when the device is disconnected. Most smart phones have a “dynamic” IP address when connecting to the Internet, which changes each time the smart phone connects to the Internet.

Voice over Internet Protocol (“VoIP”) is transmission of voice signals over the Internet using the TCP/IP protocol. VoIP is very popular because VoIP avoids long distance telephone charges from conventional public switched telephone networks.

Smart phones can be considered to have various “layers.” Hardware components that perform various functions are the hardware layer. The hardware components are controlled at a very basic level by a Basic Input and Output “BIOS” layer. An operating system, such as Apple's iOS, Google's Android, Windows, Blackberry and others, controls the hardware layer by interfacing with the BIOS layer.

Users download applications (“apps”) from Apple's iStore or Google's Play Store, which interface with the operating system layer, in order to enable the smart phone to perform various useful functions. Usually, the hardware, BIOS and operating system layers are already included in the smart phone when it is first sold. Some apps are also included in the smart phone when it is first sold, but most apps are created by independent companies that are not affiliated with the seller of the smart phone.

There are currently many companies offering third-party applications that allow voice and video conferencing over VoIP. Some of these include the Skype, Viber, Google, and Vonage. As used herein, “third-party apps” shall include all third-party voice and video calling applications such as those offered by Skype, Viber, Google and Vonage.

Use of third-party apps has major disadvantages.

For example, when a user is on a VoIP call using these third-party apps, and receives a GSM, 3G or 4G call, the VoIP call is put on hold so that the user can answer the GSM, 3G or 4G call. The user cannot conference the GSM, 3G or 4G call with the VoIP call. In addition, when the user is on a VoIP call and dialing a GSM call for conferencing, the VoIP call is automatically put on hold, and the user is unable to connect to the VoIP call for conferencing after dialing the GSM call. Similarly, when a user is on a GSM call, a VoIP voice or video call cannot be placed over third-party VoIP applications, while a GSM call is in progress. To place a call via these third-party apps, a user must first end the current GSM call. Moreover, when a user is on a VoIP call, and there is an incoming GSM call, the smart phone will notify the user that a GSM call is incoming and ask whether to answer or reject the GSM call. If the GSM call is answered, the VoIP call is put on hold.

Further, from the time the GSM call begins ringing, the VoIP call is automatically muted. This inability to conference VoIP and GSM calls is a major problem because many parts of the World have GSM networks, but do not have voice or video calling on their devices. In particular, persons in countries that only have GSM networks cannot simultaneously communicate or conduct business with other persons who use GSM and also other persons who use VoIP. Many smart phones are able to make calls using VoIP by downloading a VoIP app, such as Skype, which connects with a VoIP server. The VoIP application requires that the user import the smart phone's contact list to that VoIP application's address book. The VoIP application then tells who else is presently using that VoIP application and who is presently connected and available to communicate. The VoIP application's address book and the smart phone's contacts list can also be synchronized. However, downloading apps introduces the risk of downloading viruses or other malware, and apps consume power, memory, and Internet bandwidth. Also, the phone hangs up, downloads cookies and fills up device storage, which reduces the speed of the phone's OS. Further, many apps expose the user to advertising.

Further, even after downloading a third-party application, the user must follow a cumbersome process in order to configure the smart phone to make VoIP calls. For example, with or without the VoIP application on mobile devices, the user must go to a profile setup for Skype to connect, and on Skype SIP profiles page, the user must setup a SIP user account (possibly requiring a subscription or pay-as-you-go service) from a VoIP service provider such as Skype or Viber to get a SIP address, as a SIP client. (Smart phone and Wi-Fi enabled mobile phones may have SIP clients built into their Firmware or available as an application download.)

To set up a SIP address (similar to creating an email account with Google or Yahoo) on a computer or mobile device, the user needs to configure the SIP client by filling the required fields, a new user name and password, display name, domain, and domain proxy. The user then provides the SIP addresses to others who also use the same SIP (share the SIP addresses just like phone numbers to make VoIP calls.)

When the caller wishes to make a VoIP or video call to a recipient, the caller must be connected to the VoIP server, so that the VoIP server can assign the caller a dynamic IP address.

Further, the recipient must also be connected to the VoIP server, so that the VoIP server also has the recipient's dynamic IP address. Because the VoIP server has both the caller's and the recipient's dynamic IP addresses, the VoIP call can be sent and received. However, if either the caller or the recipient is not connected to the VoIP server, the VoIP or video call cannot be placed, because the VoIP server will not have the IP address of the unconnected party. Thus, in order to assure receipt of VoIP and video calls, users and recipients must remain connected to the VoIP server at all times, if they wish to make or receive VoIP or video calls. However, this requires that the VoIP app be running on the smart phone during all these times, which consumes computer memory, battery power, and Internet bandwidth, causes phone hang-ups (and sometimes needs to re-start), interrupts phone conversations or terminates phone calls, and exposes the user to advertisements while the VoIP app is running.

### SUMMARY

The present invention is a smart phone with VoIP Circuitry that enables the smart phone to make and receive voice and video calls and text messages over VoIP through a data network and with GSM circuitry that enables the smart phone to make and receive voice and text messages through a GSM phone network. The present invention creates a unified user experience for sending and receiving phone calls, video calls, text messages and conferencing over VoIP, and as well as sending and receiving phone calls, make conferencing, and text messages over the GSM phone network. These technologies are developed and integrated into the smart phone factory default phone contacts application by a real-time signaling communications protocol used for controlling voice, video, messaging, or conferencing over Internet protocol (IP) networks, which works in the phone background.

The present invention described herein also includes a VoIP and GSM conference call technology which allows a smart phone user to host conference calls between other VoIP voice callers, VoIP video callers, and GSM voice callers. The VoIP and GSM conference technology is integrated into the smart phone by mixing software in the device and into the default phone operating system (OS) layer.

Preferably, all smart phones according to this invention are connected to the same set of VoIP servers by default, to create a VoIP Intranet network. All such smart phones in the VoIP intranet network can communicate with each other using VoIP, thereby avoiding charges for using the public switched circuit network.

### BRIEF DESCRIPTION OF DRAWINGS

FIG. 1A illustrates a typical example of a native home screen interface.

FIG. 1B illustrates an exemplary user contacts interface presented to the user as a result of the VoIP application of the present invention invoking the phone's native user contacts interface

FIG. 1C is an illustration of possible embodiments of icons that may appear next to a particular contact's name in the contact list

FIG. 2A illustrates an exemplary add contact interface presented to the user as a result of a VoIP application invoking the native add contacts interface.

FIG. 2B illustrates exemplary user contacts interface where the drop down menu is expanded to show each of the different options available to user.

FIG. 3 Illustrates an exemplary view contact user interface presented to the user as a result of a VoIP application invoking the native view contact user interface.

FIG. 4 illustrates and exemplary keypad user interface that is presented to the user as a result of the VoIP application invoking the native incoming call user interface.

FIG. 5 illustrates and exemplary call log interface that is presented to the user as a result of the VoIP application invoking the native call log interface.

FIG. 6A illustrates a call ended interface that is presented to the user as a result of the VoIP application invoking the native call ended interface when user ends a call with a particular contact

FIG. 6B illustrates an alternative call ended interface that is presented to the user as a result of the VoIP application invoking the native call ended interface.

FIG. 7 is a system diagram of a preferred embodiment of the VOIP voice and video and GSM voice conferencing system of the improved smart phone of the subject invention.

FIG. 8 illustrates an exemplary dialer interface that is presented to the user as a result of the VoIP application invoking the native dialer interface when user is calling a particular contact.

FIG. 9 illustrates an exemplary on-call interface that is presented to the user as a result of the VoIP application invoking the native dialer interface when user is calling a particular contact.

FIG. 10 illustrates an exemplary merge call interface that is presented to the user as a result of the VoIP application invoking the native merge call interface.

FIG. 11 illustrates an exemplary conference call interface that is presented to the user as a result of the VoIP application invoking the native conference call interface when on a conference call with two or more callers.

FIG. 12 is a flowchart depicting a method for conferencing smart phone user with two or more other callers.

FIG. 13 is a flowchart of describing the process needed for two users of the present invention to connect to the VoIP server though the add contacts user interface.

FIG. 14 is a flowchart illustrating the steps taken to upgrade an existing compatible smart phone.

### DETAILED DESCRIPTION OF THE EMBODIMENTS

The present invention is described below referring to the accompanying drawings, wherein like numerals refer to like or corresponding elements throughout. It should be understood, however, that the drawings and detailed description relating thereto are not intended to limit the claimed subject matter to the particular form or embodiment disclosed. Rather the intention is to cover all modifications, equivalents, and alternatives for failing with the spirit and scope of the claimed subject matter.

The present invention described herein creates a unified user experience for sending and receiving VoIP phone calls, VoIP Conferencing, VoIP video calls, and VoIP text messages over the GSM mobile data network, and sending and receiving phone calls and text messages over the GSM phone network. By modifying a number of the smart phone's native user interfaces, the present invention allows a user to make and receive voice and video calls over VoIP, send and receive text messages over VoIP, and host VoIP conference calls as well as make and receive voice calls and send and receive text messages over the GSM phone network through a unified set of user interfaces.

These technologies are developed and integrated into the smart phone by VoIP application software (installs as an upgrade application software on smart phones), which can be downloaded by the user or preinstalled into the smart phone. Because the application modifies the smart phone's native user interfaces, the application appears to work seamlessly in the phone's background without the user knowing that the present invention is running on the smart phone.

The present invention described herein also includes a VoIP and GSM conference technology which allows a smart phone user to host conference calls between other users VoIP voice callers, VoIP video callers, and GSM voice callers. The VoIP and GSM conference technology is integrated into the smart phone by mixing software installed into the default phone operating system software layer.

Preferably, all smart phones according to this invention are connected to the same set of VoIP servers by default, to create a VoIP Intranet network. All such smart phones in the VoIP intranet network can communicate with each other using VoIP, thereby avoiding charges for using the public switched circuit network. Each of these features are discussed more fully below.

As part of the unified user experience, the present invention updates the phone's native user interfaces to include additional functionality described in this invention.

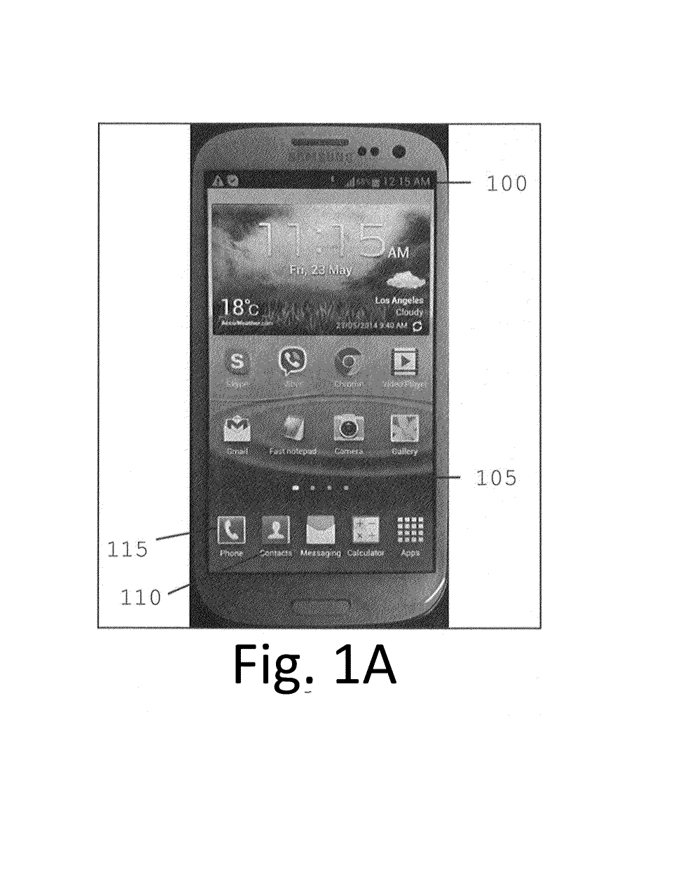

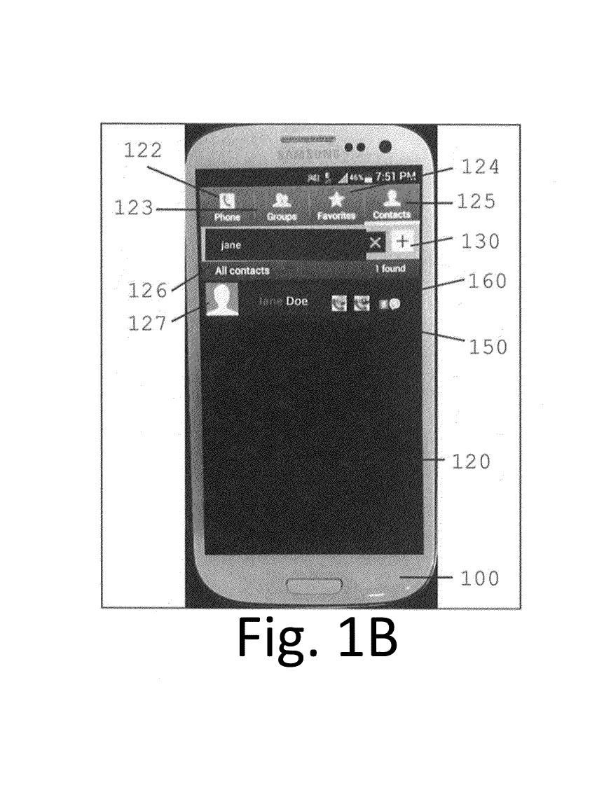

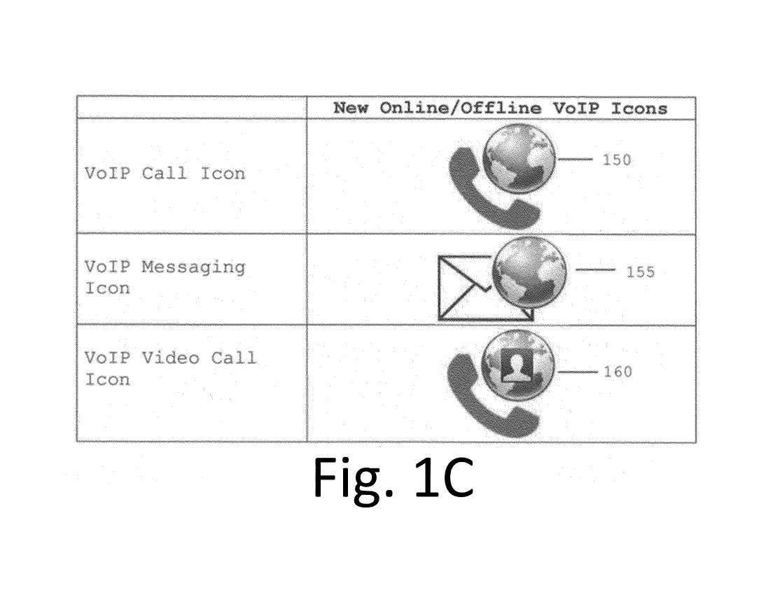

FIG. 1A illustrates a typical example of a native home screen user interface 105. Native home screen user interface 105 of smart phone 100 typically includes an icon 110, often labeled Contacts, that when clicked by user opens the phone's native user contact interface.

Native home screen user interface 105 of smart phone 100 also typically includes an icon 115, often labeled Phone, that when clicked by user opens a native keypad user interface.

Smart Phone with Improved User Contacts Interface

Smart phones typically have a native user contacts interface, which allows a smart phone user to add and save contact information to a contact list stored in the smart phone's memory. As part of the unified user experience, the present invention includes an improved user contacts interface.

FIG. 1B illustrates an exemplary user contacts interface 120 presented to the user as a result of the VoIP application of the present invention invoking the phone's native user contacts interface. User contacts interface 120 includes a phone tab 122, a group tab 123, a favorites tab 124, and a contacts tab 125.

By default, contacts tab 125, which contains a contact list 126 of all contacts saved by the smart phone user, is displayed to the user.

When a user clicks on phone tab 121, an improved keyboard user interface will be displayed to the user, which will allow the user to make voice and video calls via VoIP as well as voice calls via the GSM phone network. The improved keyboard user interface is more fully described below.

In this example, FIG. 1B illustrates contact user interface 120 of a user, who has saved a single contact 127 to the smart phone 100. The contact user interface 120 also allows a user to click on a particular contact saved in the list of contacts which opens a view contact user interface, which allows a user to view that particular contact's saved contact information.

Contacts tab 125 also includes a plus button 130 that when clicked opens an improved add contact interface that will allow a user to add and save a new contact's information. The improved add contact interface is more fully described below.

One or more icons may appear next to a particular contact's name. Each icon indicates whether the contact has voice calling over VoIP, video calling over VoIP, text messaging over VoIP, voice calling over GSM network, or text messaging over GSM network available.

FIG. 1C is an illustration of possible embodiments of icons that may appear next to a particular contact's name. The VoIP call icon 150 appears when VoIP voice calling is available for that particular contact. The VoIP Messaging icon 155 appears when sending and receiving text messaging over VoIP is available. The VoIP video call icon 160 appears when making and receiving voice calls via VOIP is available.

Referring back to FIG. 1B, VoIP call icon 150 and VoIP video call icon 160 appear next to contact 127 indicating that contact 127 has voice and video calling over VoIP technology available to it.

### Improved Add Contact User Interface

As part of the unified user experience, the present invention includes an improved add contact user interface 200 that modifies the phone's native add contact user interface, which allows a smart phone user to add and save contact information to a contact list stored in the smart phone's memory.

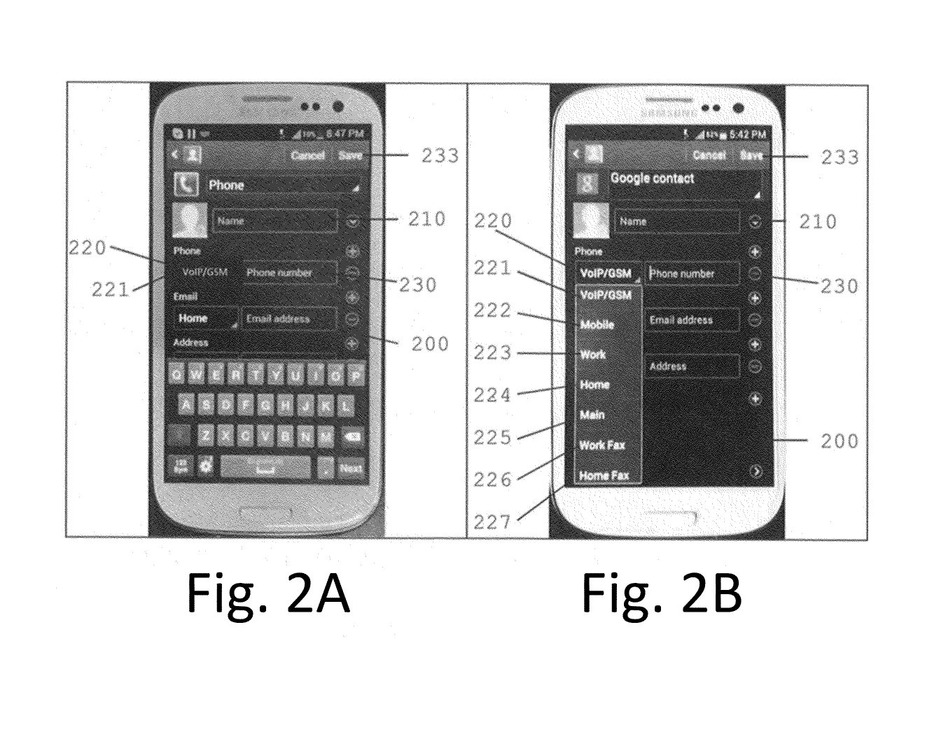

FIG. 2A illustrates an exemplary add contact interface 200 presented to the user as a result of a VoIP application invoking the native add contacts interface. Add contacts interface 200 is displayed when the user opens the add contact user interface as described in the previous section. Add contacts interface 200 contains a name text box 210 that allows a user to enter the contact's name, a drop down menu 220 a phone number text box 230 that allows a user to insert a phone number, a save button 233, as well as other fields for entering information a person usually saves in a contact book such as address, email, notes, etc. Drop down menu 220 will contain at least one VoIP/GSM option 221 and can contain other options such as Mobile, Work, Work Fax, Main, and Home Fax. Drop down menu 220 displays the VoIP/GSM option to user by default.

FIG. 2B illustrates exemplary user contacts interface 200 where drop down menu 220 is expanded to show each of the different options available to user. In this illustration, expanded drop down menu 220 displays various options such as VoIP/GSM option 221, a Mobile option 222, a work option 223, a home option 224, a work fax option 225, and a home fax option 226.

### Improved View Contact Interface

A typical smart phone includes a native view contact interface that allows a user to view a contact's information that has been stored on the smart phone. As another aspect of the unified user experience, the present invention includes an improved view contact user interface that modifies the phone's native view contact user interface.

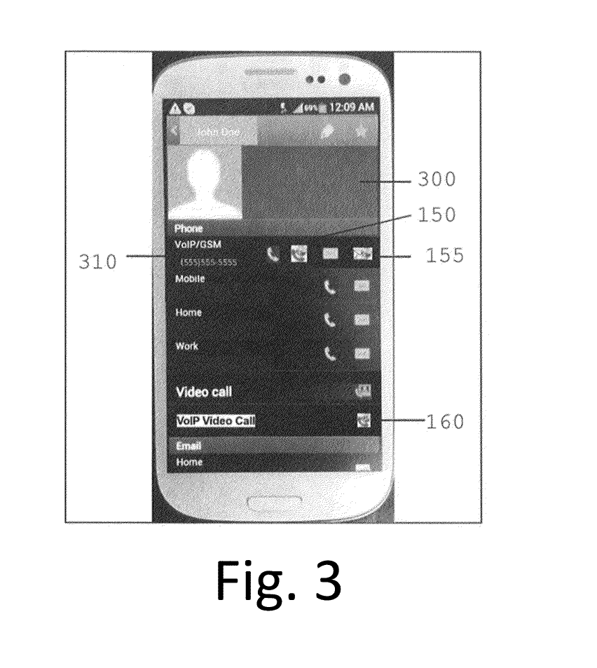

FIG. 3 Illustrates an exemplary view contact user interface 300 presented to the user as a result of a VoIP application invoking the native view contact user interface. When a user selects a contact from contact list 126 of contact user interface 120, the view contact user interface 300 then displays all contact information for that particular contact that has been saved to smart phone 100. As illustrated, view contact user interface 300 displays the contact information of John Doe, including the phone number 310, which is the phone number that was imputed into phone number text box 230 with VoIP/GSM option 221 displayed in drop down menu 220 when the contact was saved. If the user saved a phone number in phone number text box 230 and VoIP/GSM option was displayed in drop down menu 220 when the contact information was saved, the contact may have one or more of the icons discussed in FIG. 1C displayed in view contact user interface 300.

Referring to FIG. 3, in this embodiment VoIP call icon 150 and VoIP messaging Icon 155 are displayed next to phone number 310 and VoIP voice call icon 160 is displayed in a separate section below other additional information such as mobile, home and work numbers that the user has saved for the contact.

From view contact user interface 300, a smart phone user is also able to make VoIP voice and video calls and send VoIP text messages by selecting the appropriate icon. If smart phone user selects VoIP call icon 150, a VoIP voice call will be made to phone number 310. If the smart phone user selects VoIP messaging icon 155, a VoIP text message will be sent to phone number 310. Finally, if the smart phone user selects VoIP video call icon, a VoIP video call will be made to phone number 310.

### Improved Keypad Interface

As part of the unified user experience, the present invention also includes an improved keypad interface. The keypad user interface adds two new functions to the phone's native keypad user interface which allows a user to make voice and video calls via VoIP though the keypad interface.

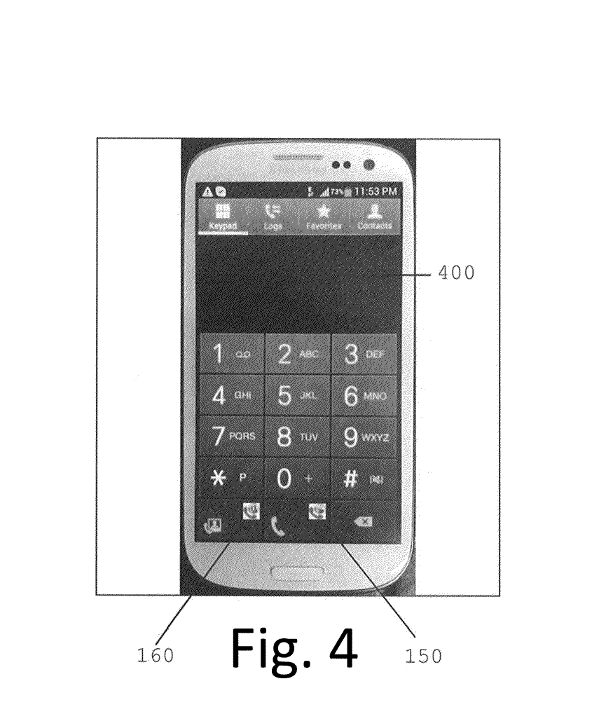

FIG. 4 illustrates and exemplary keypad user interface 400 that is presented to the user as a result of the VoIP application invoking the native incoming call user interface. As illustrated in FIG. 4, in addition to the standard keypad and calling options, VoIP voice icon 150 and VoIP Video icon 160 are displayed to the user. After entering a phone number, if the user clicks on VoIP voice icon 150, a voice call via VoIP is made to the phone number and if the user wants to have a VoIP conferencing, simply the user selects another VoIP contacts from the default phone contacts list and click on a VoIP voice icon of that contact and dial the number and when the VoIP call is connected, the user taps “VoIP merge” option in the calling screen and the new party is connected to the conference. Alternatively, if the user clicks on VoIP video icon 160, a video call via VoIP is made to the phone number.

### Improved Logs Interface

A smart phone typically includes a native call log interface that contains a log of dates and times of conversations a user had with a particular contact. As part of the unified user experience, the present invention also includes an improved call logs interface that allows a user to make voice and video calls via VoIP though the call log interface.

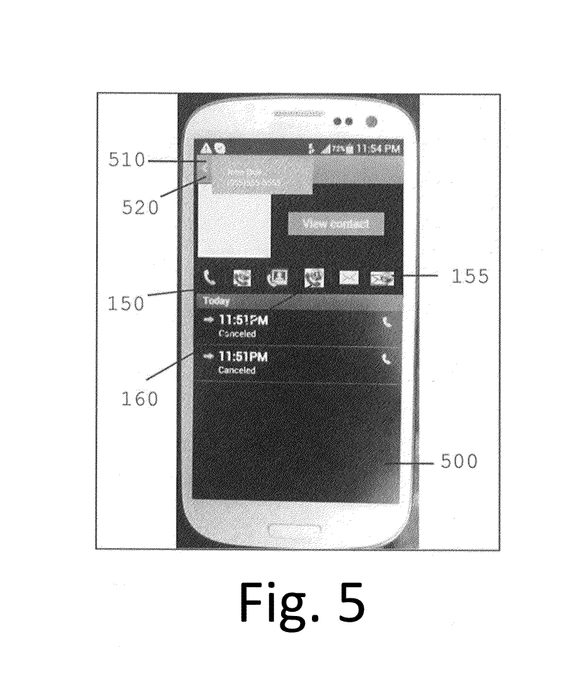

FIG. 5 illustrates and exemplary call log interface 500 that is presented to the user as a result of the VoIP application invoking the native call log interface. As illustrated in FIG. 5, VoIP voice icon 150, VoIP messaging 155, and VoIP Video icon 160 are displayed to the user. If the user clicks on VoIP voice icon 150, a voice call via VoIP is made to the phone number 520 of the desired contact, whose name 510 is listed at the top of the call log interface 500. If the user clicks on VoIP video icon 160, a video call via VoIP is made to the phone number 520 of the desired contact, whose name 510 is listed at the top of the call log interface 500. If the user clicks on VoIP text messaging icon 155, a text message via VoIP will be sent to the phone number 520 of the desired contact, whose name 510 is listed at the top of the call log interface 500.

### Improved Call Ended Interface

A smart phone typically includes a native call ended interface that displays to a user after the user concludes a voice or video call with another person. As part of the unified user experience, the present invention also includes an improved call ended interface that allows a user to make a voice and video calls via VoIP to said person though the call ended interface.

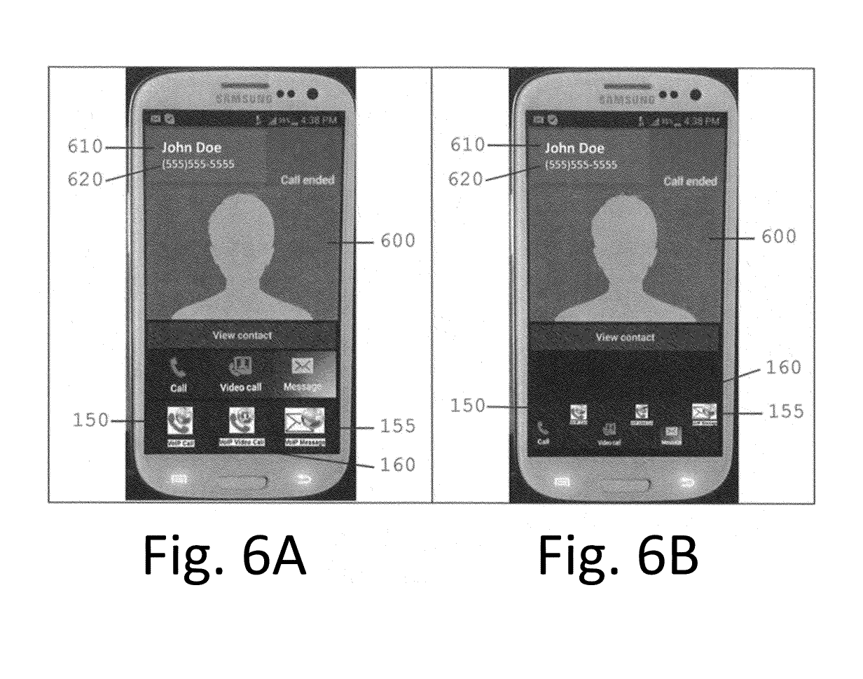

FIG. 6A illustrates an exemplary call ended interface 600 that is presented to the user as a result of the VoIP application invoking the native call ended interface when user ends a call with a particular contact. As illustrated in FIG. 6A, the contact's name 610 and phone number 620 are listed on the top of call ended interface 600. VoIP voice icon 150, VoIP messaging 155, and VoIP Video icon 160 are displayed to the user. If the user clicks on VoIP voice icon 150, a voice call via VoIP is made to the phone number 620 of the desired contact, whose name 610 is listed at the top of the call ended interface 600. If the user clicks on VoIP video icon 160, a video call via VoIP is made to the phone number 620 of the desired contact, whose name 610 is listed at the top of the call ended interface 600. If the user clicks on VoIP text messaging icon 155, a text message via VoIP will be sent to the phone number 620 of the desired contact, whose name 610 is listed at the top of the call ended interface 600.

FIG. 6B illustrates an alternative call ended interface 600 that is presented to the user as a result of the VoIP application invoking the native call ended interface. As illustrated in FIG. 6B, VoIP voice icon 150, VoIP messaging 155, and VoIP Video icon 160 are displayed to the user. If the user clicks on VoIP voice icon 150, a voice call via VoIP is made to the phone number 620 of the desired contact, whose name 610 is listed at the top of the call ended interface 600. If the user clicks on VoIP video icon 160, a video call via VoIP is made to the phone number 620 of the desired contact, whose name 610 is listed at the top of the call ended interface 600. If the user clicks on VoIP text messaging icon 155, a text message via VoIP will be sent to the phone number 620 of the desired contact, whose name 670 is listed at the top of the call ended interface 600.

### Conferencing Voice, Video and VoIP Calls

Another aspect of the present invention is an improved smart phone that integrates VoIP voice, VoIP video call, VoIP text messaging, over a data network or Wi-Fi/mobile hotspot and cellular GSM phone conferencing. The conferencing capability can be achieved by application software or operating system software.

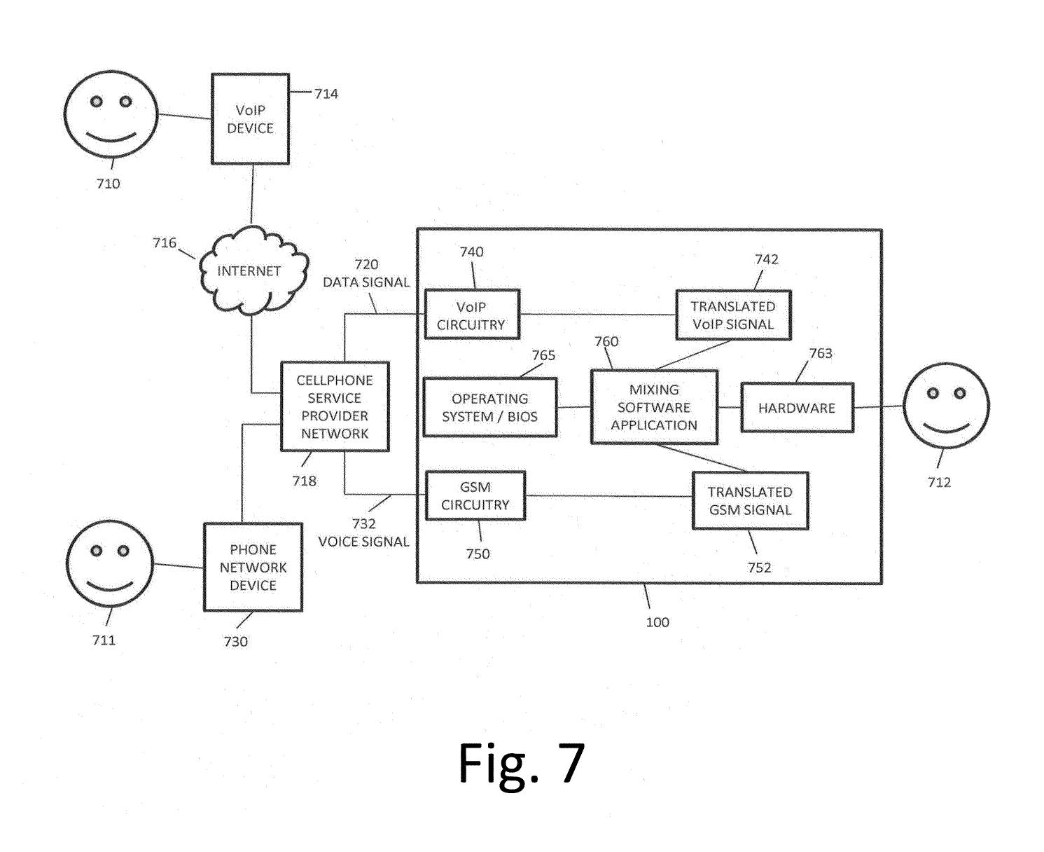

FIG. 7 is a system diagram of a preferred embodiment of the VOIP voice and video and GSM voice conferencing system of the subject invention. FIG. 7 discloses a conference call between a first caller 710, a second caller 711, and a smart phone user 712 is disclosed.

As illustrated in FIG. 7, first caller 710 calls smart phone user 712 through a VoIP device 714 such as a VoIP phone or an electronic device with third party VoIP software such as Skype. The call may be a voice call or a video call. The voice and/or video signals from VoIP device 714 are transmitted over the internet 716 using the VoIP protocol to the cellular service provider network 718 of smart phone user 712. Cellular service provider network 718 transmits the data signal 720 to smart phone 712. The VoIP circuitry 740 converts the data signal 720 into a translated data signal 742.

Second caller 711 calls smart phone user 712 through a phone device 730, such as a traditional telephone over the public switched telephone network, a radio telephone, or cellular phone capable of GSM, 3G, 4G, or other cellular phone technology. When second caller 711 speaks, signals from phone device 730 are transmitted to the cellular service provider network 718. Cellular service provider network 718 transmits a voice signal 732 to the GSM circuitry 750 of smart phone 712. GSM Circuitry 750 converts the phone signal 132 into a translated GSM signal 752.

When smart phone user 712 activates the telephone conferencing feature of smart phone 702, by for example, pressing a “merge” option made available on smart phone 712, smart phone 712 automatically pairs the two signals with the help of a software application 760 and hardware 763 of smart phone 712 and/or a VoIP Server. It is anticipated that software application 760 will be embedded on the operating system or BIOS 765 of smart phone 712.

The conferencing functionality of the present invention is accessed through an improved dialer, on-call, merge, and conference call interfaces described below.

### Improved Dialer Interface

A smart phone typically has a dialer interface that is presented to the user while the smart phone is dialing a particular contact. As part of the unified user experience, the present invention also includes an improved dialer interface that allows a user to invoke the conferencing technology described above by add additional caller GSM voice, VoIP voice, and VoIP video callers.

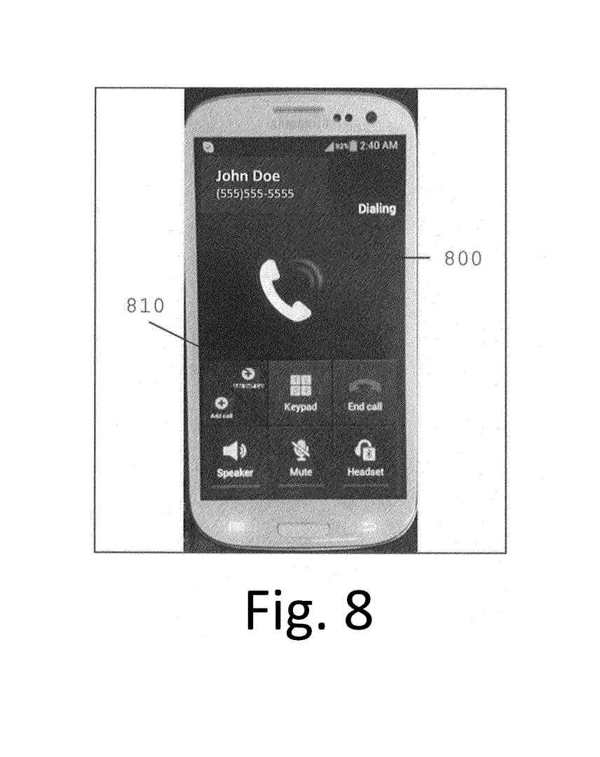

FIG. 8 illustrates an exemplary dialer interface 800 that is presented to the user as a result of the VoIP application invoking the native dialer interface when user is calling a particular contact. In addition to the functions typically shown in the smart phone's native dialer interface, a add VoIP call icon 810 is presented to the user in dialer interface 800 as illustrated in FIG. 8.

### Improved On-Call Interface

A smart phone typically has an on-call interface that is presented to the user while the user is on a call with a particular contact. As part of the unified user experience, the present invention also includes an improved on-call interface that allows a user to invoke the conferencing technology described above by adding additional GSM voice, VoIP voice, and VoIP video callers.

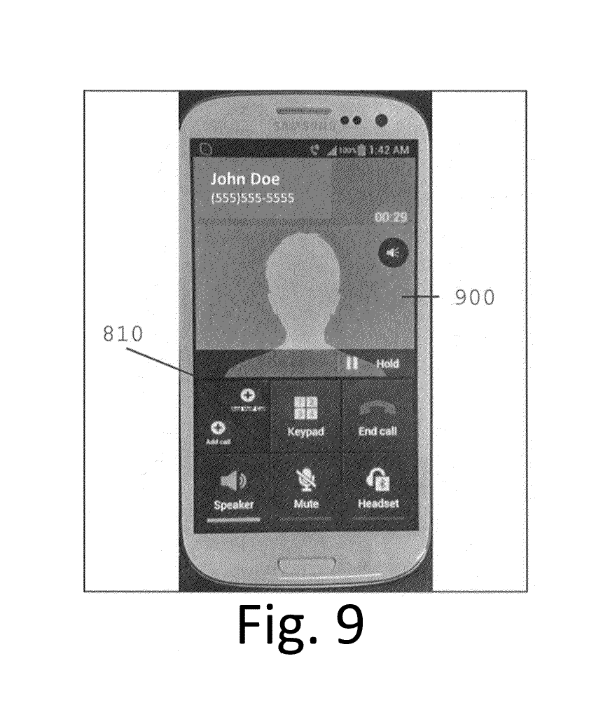

FIG. 9 illustrates an exemplary on-call interface 900 that is presented to the user as a result of the VoIP application invoking the native dialer interface when user is calling a particular contact. In addition to the functions typically shown in the smart phone's native on-call interface, add VoIP call icon 810 is presented to the user in on-call interface 900 as illustrated in FIG. 9.

### Improved Merge Call Interface

As part of the unified user experience, the present invention also includes an improved merge call interface that allows a user to invoke the conferencing technology described above by merging VoIP voice calls, VoIP video calls, and voice calls over a GSM phone network.

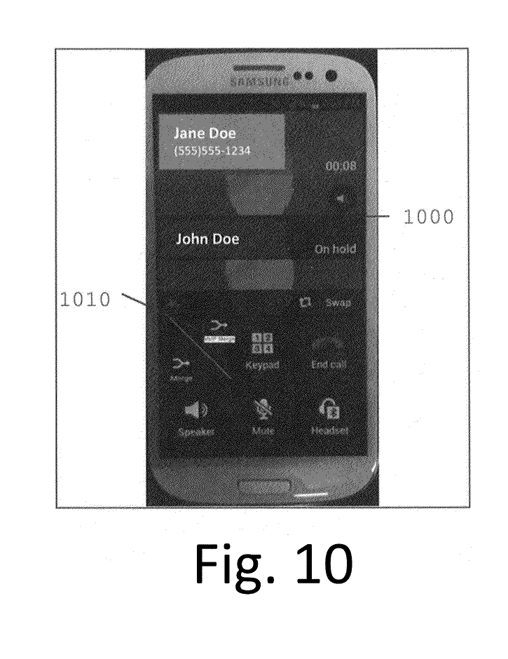

FIG. 10 illustrates an exemplary merge call interface 1000 that is presented to the user as a result of the VoIP application invoking the native merge call interface. Merge call interface 1000t is displayed to the user when user has two or more VoIP voice calls, VoIP video calls, and/or voice call over the GSM phone network calls and would like to merge the calls together in one conference call. In addition to the functions typically found in the phone's native merge-call interface, a merge call icon 1010 is presented to the user in on-call interface 1000, as illustrated in FIG. 10.

### Improved Conference Call Interface

A smart phone typically has a conference call interface that is presented to the user while the user is in a conference call with two or more other callers. As part of the unified user experience, the present invention also includes an improved conference call interface that allows a user add additional GSM voice, VoIP voice, and VoIP video callers to the existing conference call.

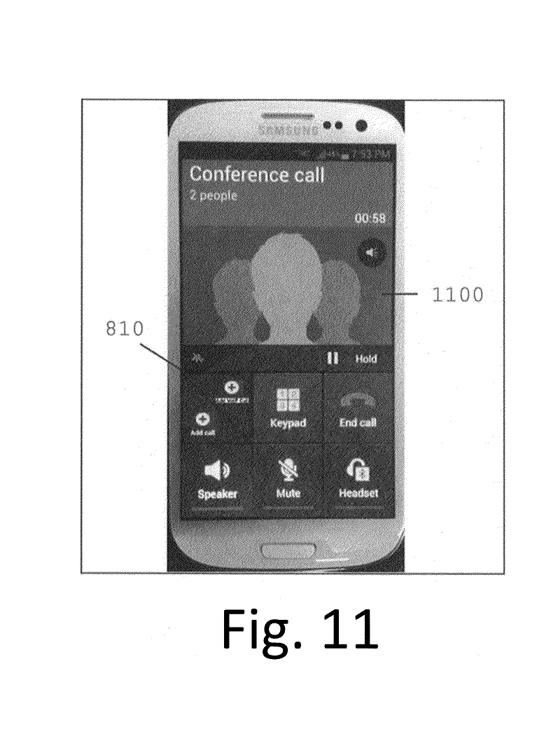

FIG. 11 illustrates an exemplary conference call interface 1100 that is presented to the user as a result of the VoIP application invoking the native conference call interface when on a conference call with two or more callers. As illustrated in FIG. 11, in addition to the functions typically found in the phone's native conference call interface, add VoIP call icon 810 is presented to the user in conference call interface 1100.

### Making Conference Calls

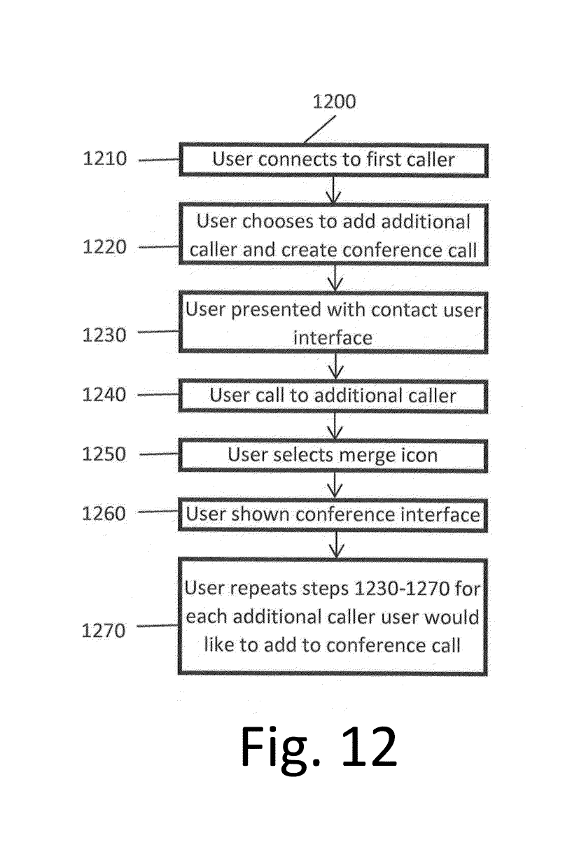

FIG. 12 is a flowchart depicting a method for conferencing smart phone user with two or more other callers. Flowchart 1200 begins with step 1210 where smart phone user connects to a first caller via a voice call through GSM phone or data networks or video call through the GSM data network of smart phone. As described above, if user wants to make a VoIP voice call or video call, the user can connect to first caller by (1) selecting VoIP call icon 150 or VoIP video call icon 160 in view contact user interface 300 described in FIG. 3 above, (2) by entering the first caller's phone number directly into keypad user interface 400 and selecting the VoIP call icon 150 or VoIP video call icon 160 described FIG. 4 above, (3) by selecting the VoIP call icon 150 or VoIP video call icon 160 in call log interface 500 described in FIG. 5 above, (4) by selecting the VoIP call icon 150 or VoIP video call icon 160 in call ended interface 600 described in FIG. 6 above, or (5) by accepting the first caller's incoming voice or video call.

In step 1220, user selects add VoIP call icon 810 either from the dialer interface 800 if the first caller has not yet answered the call or from on-call interface 900 if the first caller has answered the call.

In step 1230, user is presented with the user contacts interface 120 described above in FIG. 1B.

In step 1240, user makes a VOIP voice, VOIP video call, or voice call via GSM phone network to the second caller. If the second caller's contact information is saved in the contact list, user selects the contact's name from the contact list, which opens the view contact user interface 300. From view contact user interface 300, if user wants to make a VoIP voice or video call, user can select VoIP call icon 150 or VoIP video call icon 160 as described in FIG. 3. Alternatively, the second caller's contact information is not saved in the list of contacts, user can select phone tab 122, which opens keypad user interface 400 described in FIG. 4. User can enter the second caller's phone number directly into the keypad user interface 400. If user wants to make a VoIP voice or video call, user can select VoIP call icon 150 or VoIP video call icon 160.

In step 1250, user is presented with merge call interface 1000 described in FIG. 10 above. User selects merge call icon 1010 to establish the conference call between user, first caller, and second caller.

In step 1260, the smart phone displays to user the conference call interface 1100 described in FIG. 11 above.

In step 1270, smart phone user can continue to add additional callers to the conference call by selecting add VoIP call icon 810 from the conference call interface or the add call icon that is made available by the phone's native conference call interface and then repeating steps 1230 through 1270 for each additional caller that user would like to be joined to the conference call.

### Call Barring Functionality

To avoid interruption by GSM calls while a user is on a VoIP voice or video call, VoIP conference call or sending VoIP text messaging, the present invention can temporarily block incoming voice calls via a GSM phone network by default when a user is on a VoIP voice or video call, VoIP conference call or sending VoIP text messages.

In the present invention, the moment a user selects VoIP call icon 150, VoIP messaging icon 155, VoIP video call 160, or merge call icon 1010, the phone is configured to automatically change the phone's native call settings to disable the phone's capability of accepting all incoming calls and text messages via the phone's GSM phone network. After the VoIP voice, video, text message or conference call is ended, the phone automatically changes its call barring settings to enable voice and text messages over the GSM phone network.

### Creating New Contact and Saving to Central VoIP Server

Preferably, by default, all smart phones according to this invention are connected to the same central VoIP server, creating a VoIP Intranet network where each smart phone is designated a static/dynamic IP address. Instead of user names and passwords, the IP addresses are identified by the mobile phone number that is entered into the VoIP/GSM field at the time the new contact is saved.

The present invention anticipates having an advanced encryption standard with complete security and privacy. All data that is transferred to the central VoIP server and across the VoIP network will be encrypted with a 256-bit encryption to ensure strong privacy. As a result, even if unauthorized users intercept the data that is being transferred, these unauthorized users will be unable to decode the data.

The VoIP server is capable of routing VoIP voice, VoIP video, texting over VoIP, and VoIP and GSM conferencing (collectively, the “VoIP services) worldwide through a data network. If users have a mobile plan with unlimited data plan, which is recommended, users of the present invention can communicate with other users worldwide over the central VoIP server, thereby avoiding charges for using the public switched circuit network and for mobile phone charges for “voice minutes”.

The present invention does not function like third-party apps, which installs and adds a shortcut “icon” on the phone's home screen and requires the user to login to the third-party apps servers, which use usernames and passwords to authenticate and identify users of the application. In addition, unlike other third-party apps, there is no way for users to search for other users in the network by their name, email addresses, or phone number.

Smart phone users with the present invention are always logged-in to the VoIP services in the phone background by default via a connection to the central VoIP server. VoIP services become active between two users with the present invention as soon as both users install the present invention onto their smart phones and each user adds the other user's name, VoIP/GSM phone number to its contact list through improved or upgraded default phone contact user interface 200. In other words, the central VoIP server activates the VoIP services only when two users have the present invention installed onto their smart phones and each user through the add contact user interface 200 saves the other contact's name, phone number with the VoIP/GSM option displayed in drop box 220.

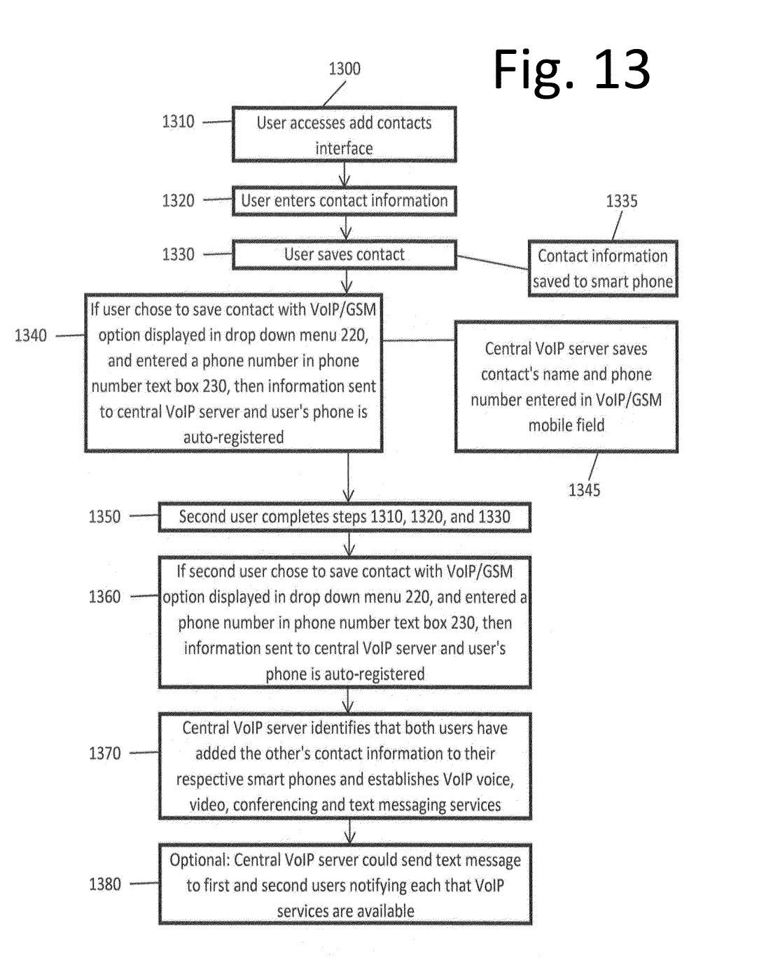

FIG. 13 is a flowchart of describing the process needed for two users of the present invention to connect to the VoIP server though the default phone add contacts user interface 200.

The flowchart begins with step 1310 as the first smart phone user accesses add call interface 200 by selecting add button 130 on contact user interface 120 as described in the description of FIG. 1B, supra. As illustrated in FIG. 2A, drop down box 220 displays VoIP/GSM by default.

In step 1320, first smart phone user enters contact information of second smart phone user. While no fields are required, first smart phone can also enter contact information for second smart phone user such as name, VoIP/GSM phone number, additional phone numbers, email, and other addresses. In this step, first smart phone user can decide to keep the VoIP/GSM option or choose another option from drop down box 220.

In step 1330, once all contact information for the new contact is entered, first smart phone user selects save button 233, which saves the newly entered contact information of second smart phone user to the improved smart phone.

In step 1335, second smart phone user's name will now appear in the contact list of first smart phone user's contact user interface 120.

In step 1350, if first smart phone user chose to save the second user's information with VoIP/GSM option 221 displayed in drop down menu 220 and entered a phone number in text box 230, the new contact registration information of second smart phone user is automatically sent to the central VoIP server when it is saved.

In step 1355, the central VoIP server saves second smart phone user's name as the username, second smart phone user's phone number as the password in the VoIP central server's database.

In step 1360, second smart phone user conducts steps 1310, 1320, 1330, and 1340 onto second user's smart phone.

In step 1370, if second user chose to save the first user's information with VoIP/GSM option 221 selected and entered phone number in text box 230, the new contact registration information of first smart phone user is sent to the central VoIP server.

In step 1380, the central VoIP server identifies that first and second users have each added the other to its respective contact lists with VoIP/GSM option 221 selected and the VoIP server automatically makes the VoIP services available to both users. When this occurs, VoIP call icon 150, VoIP messaging icon 155 and VoIP video call icon 160 are displayed in the contact user interface 120 as described in FIG. 1B, view contact user interface 300 as described in FIG. 3, the log interface 600 as described in FIG. 6, and call ended interface 700 as described in FIG. 7.

As long as first and second user's smart phones remain connected to the central VoIP server, VoIP call icon 150, VoIP messaging icon 155, and VoIP video icon 160 will remain enabled including VoIP conferencing feature will remain activate along with the user online/offline status showing in the default phone contacts list. The central VoIP server automatically verifies a user's phone status at the time of availing VoIP voice, video, and text messaging services.

As an optional step 1390, the central VoIP server could send a text message to first and second users notifying each that the VoIP services provided by the central VoIP server is now enabled.

### Upgrading Smart Phones

The present invention anticipates four different ways of installing and upgrading the existing smart phone to an improved smart phone 1. The present invention can be pre-installed in new original equipment manufacturer (OEM) phones or 2. OEM can directly send the pop-up update on notifications panel to all of their smart phones around the world via the Internet with a notifications for example, “New Update need approval” and the end-user taps to the pop-up update link on notifications panel to install the new “upgraded” smart phone VoIP application software and once installed, the phone is automatically upgraded. At the same time, the phone user is also registered in the central VoIP server and the upgraded app is also started working in the phone background and user can enjoy VoIP services immediately on the phone or 3. OEM can automatically upgrade their phones around the globe without having the end-user taps the pop-up update on notifications panel to install the new VoIP application software or can also be available for download via application stores such as the Google Play store.

Users who download the application will be able to upgrade their existing compatible smart phones. Once the download is installed to the user's smart phone, the program will

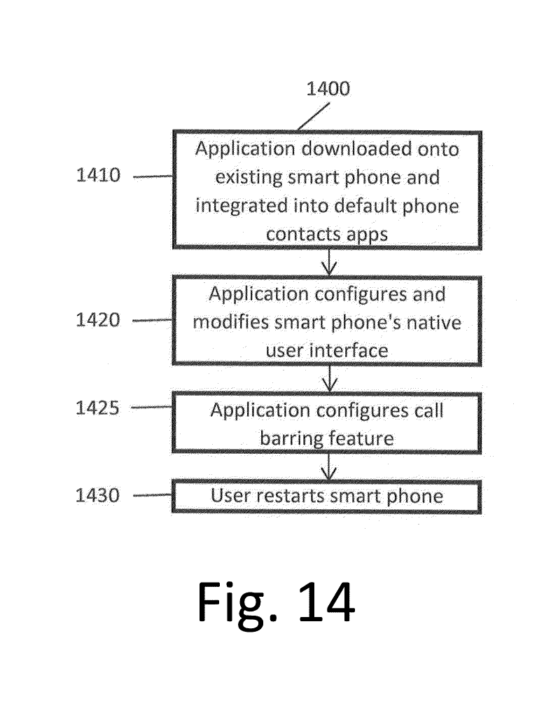

FIG. 14 is a flowchart illustrating the steps to upgrade an existing compatible smart phone by installing the new improved smart phone VoIP application software on the device, automatically integrates VoIP options into the default phone contacts application and other said user interfaces, adding the VoIP calling behavior in the default phone user contacts interface, and automatically registering new phone user in the central VoIP server, while keeping the existing GSM calling unchanged. In step 1410, user is either notified in the phone notifications screen of update by OEM phone server or user downloads the application directly from an application store such as the Google Play store. In step 1415, User downloads and installs the application.

In step 1420, the application configures and modifies the phone's native user interfaces to include VoIP call icon 150, VoIP messaging Icon 160, VoIP video call icon 160, Add VoIP call icon 810, and merge call icon 1010.

In step 1425, the application configures the call barring feature, which temporarily blocks all GSM incoming calls while the phone is on a VoIP voice or video call, sending VoIP text messages, or in a VoIP conference call.

In step 1430, user restarts the existing compatible smart phone.

1. An apparatus, comprising:
a voice over Internet Protocol (VoIP) circuitry configured to cause the apparatus to make and receive voice, video calls, and text messages over VoIP using a data network; and
a global system for mobile communication (GSM) circuitry configured to cause the apparatus to make and receive voice and text messages through a GSM network.
